(19) United States
(12) Patent Application Publication
(10) Pub. No.: US 2023/0046715 A1
(43) Pub. Date: Feb. 16, 2023

(54) THERMAL STRUCTURE COUPLING ANAYSIS METHOD OF A SOLID ROCKET MOTOR NOZZLE CONSIDERING THE STRCTURAL GAPS

(71) Applicants: Lin Sun, Xian (CN); Delei Shi, Xian (CN); Yu Zhao, Xian (CN); Futing Bao, Xian (CN); Chen Cheng, Xian (CN); Hao Xu, Xian (CN)

(72) Inventors: Lin Sun, Xian (CN); Delei Shi, Xian (CN); Yu Zhao, Xian (CN); Futing Bao, Xian (CN); Chen Cheng, Xian (CN); Hao Xu, Xian (CN)

(21) Appl. No.: 17/400,084

(22) Filed: Aug. 11, 2021

(51) Int. Cl. G06F 30/28; G06F 30/17

(52) U.S. Cl. CPC G06F 30/28; G06F 30/17; G06F 2111/10

(57) ABSTRACT

The invention provides a thermal structure coupling analysis method of a solid rocket motor nozzle considering the structural gaps, comprising S1: establish a model of flow field in nozzle and ascertain the cross-sectional area at different positions along the axis, perform quasi-one-dimensional isentropic flow analysis of the nozzle flow field by Newton iteration method; S2: use Bartz formula to ascertain the boundary of the nozzle convective heat transfer coefficient; S3: establish a numerical analysis project of nozzle thermal structure; a two-dimensional axisymmetric model of the nozzle thermal protection structure and a material model thereof; S4: proceed a numerical analysis of the nozzle thermal protection structure heat transfer, including model setting, material setting, contact setting, meshing, solution parameter setting, boundary condition setting, solution and result post-processing; S5: proceed a numerical analysis of the nozzle thermal protection structure thermal stress, including solution parameter setting, boundary condition setting, solution and result post-processing.

### BACKGROUND OF THE INVENTION

### 1. Field of the Invention

The invention relates to the technical field of the solid rocket motor, in particular to a thermal structure coupling analysis method of a solid rocket motor nozzle considering the structural gaps.

### 2. Description of the Related Art

Solid Rocket Motor (SRM) is a chemical rocket power plant using solid propellant, its characteristics of simple structure, mature development and high reliability make it widely used in missile weapons, launch vehicles and spacecrafts. The continuous escalation of the attack-defense confrontation requirements of aerospace technology and weapon systems has put forward the requirements of “high energy, large scale, high overload, and wide adaptation” for solid motors. Facing the nozzle thermal protection problem caused by the high-energy propellant produced to meet the long-range, strong penetration and high survival requirements of the new generation of strategic missiles, numerical analysis of nozzle thermal structure plays an irreplaceable role in improving motor design efficiency and reducing motor design cost.

During the operation of the motor, the nozzle thermal protection structure is in a special working environment, which has the characteristics of high temperature (up to 3000° C. or higher), high pressure (up to 15 MPa or higher), and high speed (up to 800-1500 m/s). The numerical analysis of its thermal structure on the engineering level, in addition to the effects of high temperature and high pressure loads, the nonlinear phenomena such as contact heat transfer and contact friction, resulting from the bonding and contact boundary between the components of the thermal protection are prone to structural gaps under force-thermal load should also be taken into consideration. Therefore, a method of analyzing the sequential coupling of solid rocket motor nozzle contact nonlinear thermal structure is required.

### SUMMARY OF THE INVENTION

Against the above problems, the invention aims to provide a method of analyzing the sequential coupling of solid rocket motor nozzle contact nonlinear thermal structure considering the thermal contact resistance and contact friction caused by structural gaps, and to enrich the fine analysis of the solid rocket motor and improve the level of the design and the technical analysis.

The invention is achieved by the following technical solutions:

A thermal structure coupling analysis method of a solid rocket motor nozzle considering the structural gaps, comprising the following steps:

S1: establish the model of flow field in nozzle and ascertain the cross-sectional area at different positions along the nozzle axis, perform quasi-one-dimensional isentropic flow analysis of flow field in the nozzle by Newton iteration method, and obtain the gas temperature T, pressure P and Mach number Ma on any section along the nozzle axis, and ascertain the pressure and temperature boundary:

$$\frac{{T}_{0}}{T} = 1 + \frac{k - 1}{2} {Ma}^{2} ;$$

$$\frac{{P}_{0}}{P} = {( 1 + \frac{k - 1}{2} {Ma}^{2} )}^{\frac{k}{k - 1}} ;$$

$$\frac{A}{{A}_{t}} = {\frac{1}{Ma} [ \frac{( k - 1 ) {Ma}^{2} + 2}{k + 1} ]}^{\frac{k + 1}{2 ( k - 1 )}} ;$$

In the formula, T₀ is the total temperature of the combustion chamber, P₀ is the total pressure, Aₜ is the area of the nozzle throat, A is the cross-sectional area along the nozzle axis, k is the specific heat ratio of the gas;

S2: use the Bartz formula to ascertain the boundary of the nozzle convective heat transfer coefficient:

$$h = \frac{C}{{d}_{t}^{0.2}} \frac{{c}_{p} {μ}^{0.2}}{P {r}^{0.6}} {( \frac{m}{{A}_{t}} )}^{0.8} {( \frac{{d}_{t}}{{R}_{c}} )}^{0.1} {( \frac{{A}_{t}}{A} )}^{0.9} σ$$

In the formula: h is the forced convection heat transfer coefficient; C is the correction coefficient, C=0.026 when it is in subsonic flow, C=0.023 when it is in supersonic flow; dₜ is the diameter of the throat; cₚ is the constant-pressure specific heat; μ is the viscosity coefficient of the gas; Pr is the Prandtl number; \dot{m} is the mass flow rate of the gas; R_{c} is the curvature radius of the curve segment of the throat; σ is the correction coefficient caused by considering the change of boundary layer parameters;

the correction coefficient thereof:

$$σ = \frac{1}{{[ \frac{1}{2} \frac{{T}_{w}}{{T}_{0}} ( 1 + \frac{k - 1}{2} {Ma}^{2} ) + \frac{1}{2} ]}^{0.65} {( 1 + \frac{k - 1}{2} {Ma}^{2} )}^{0.15}}$$

In the formula, T_{w} is the temperature of the nozzle wall; T₀ is the total temperature of the gas; k is the specific heat ratio of the gas; Ma is the Mach number flow along the nozzle axis;

wherein define the gas recovery temperature as Tᵣ:

$${T}_{r} = T [ 1 + P {r}^{1 / 3} \frac{k - 1}{2} {Ma}^{2} ]$$

wherein the Prandtl number Pr and gas viscosity coefficient μ:

$$Pr = \frac{4 k}{9 k - 5} ;$$

$$μ = 11.83 \times 1 {0}^{- 8} \times {\overline{M}}^{0.5} \times {T}^{0.6} ;$$

In the formula, M̅ is the average molar mass of the gas;

S3: proceed pre-treatment, including establishing a numerical analysis project of nozzle thermal structure; establishing a two-dimensional axisymmetric model of the nozzle thermal protection structure; establishing the material model of the nozzle thermal protection structure;

S4: proceed the numerical analysis of the heat transfer of the nozzle thermal protection structure, including model setting, material setting, contact setting, meshing, solution parameter setting, boundary condition setting, solution and result post-processing;

S5: proceed the numerical analysis of the thermal stress of the nozzle thermal protection structure, including solution parameter setting, boundary condition setting, solution and result post-processing.

Preferably, the S3 comprises the following steps:

S3.1: establish the numerical analysis project of nozzle thermal structure in ANSYS Workbench, including model module, material parameter module, heat transfer module and thermal stress module;

S3.2: establish or import the two-dimensional axisymmetric model of the nozzle thermal protection structure into the model module, and adjust the symmetry axis of the model to the Y axis;

S3.3: according to the material composition of each part of the nozzle thermal protection structure, input the density, thermal expansion coefficient, elastic parameters, thermal conductivity and specific heat parameters in the material parameter module respectively, and establish the material model of the nozzle thermal protection structure.

Preferably, the S4 comprises the following steps:

S4.1: in the heat transfer module, access the heat transfer numerical analysis setting interface Mechanical, access Geometry in the project tree on the left, and set 2D Behavior in Definition to Axisymmetric;

S4.2: under the Geometry tree in the heat transfer module, specify the materials of each structural component of the nozzle respectively;

S4.3: access Connections-Contacts, set all contact pairs, set Type to Frictional, Friction Coefficient to 0.2, set Thermal Conductance to Manual, and Thermal Conductance Value to 1000 W/(m²·K);

S4.4: access Mesh, alter the appropriate Element Size according to the size of the nozzle structure; select Update to start meshing;

S4.5: access Analysis Settings, set Step End Time according to the actual working time of the motor, Auto Time Stepping is set to off, Define By is set to Substeps, Number of Substeps is set to 100;

S4.6: select inner wall of the nozzle and add a Convection boundary; set both Film Coefficient and Ambient Temperature to Tabular Data, select Edit Data For to Ambient Temperature, set Independent Variable to Y, and enter the temperature along the axis of the nozzle obtained by the quasi-one-dimensional flow of the nozzle; select Edit Data For as Film Coefficient, set Independent Variable to Y, and enter the convective heat transfer coefficient along the nozzle axis; select the part of the outermost shell of the nozzle that is directly in contact with the air, add Convection, and set the Film Coefficient to 5 W/(m²·° C.);

S4.7: access Solution, select Solve, and proceed numerical analysis of heat transfer of nozzle thermal protection structure;

S4.8: after the solution is completed, add a post-processing item to the Solution to obtain nozzle temperature field distribution diagram at the end of the operation.

Preferably, the S5 comprises the following steps:

S5.1: in the thermal stress module, access Analysis Settings, set Step End Time to 1 s, Auto Time Stepping to off, Define By to Time, and Time Step to 1 s;

S5.2: select Suppress under Imported Load, select the inner wall of the nozzle and add a Pressure boundary, and enter the pressure along the axis of the nozzle obtained by the quasi-one-dimensional flow of the nozzle; select the boundary along the radial direction at the junction of the outermost metal part of the nozzle and the combustion chamber, add a Displacement boundary, and set axial displacement thereof to 0;

S5.3: insert Commands under Transient and enter the solution command; access Solution, select Solve and start the numerical analysis of the thermal stress of the nozzle thermal protection structure;

S5.4: after the solution is completed, add a post-processing item in Solution to obtain a thermal stress cloud diagram of the nozzle at the end of the operation.

The advantageous effects of the invention are:

1. The invention considers the performance response of the nozzle thermal protection material under high temperature and high pressure load, establishes a temperature-dependent and anisotropic material model, and more comprehensively describes the degradation process of the material performance;

2. The invention considers the structural gap problem caused by the nozzle adhesive failure and the components connection, introduces the thermal contact resistance and contact friction technology, and establishes the numerical analysis method of nozzle thermal structure sequence coupling, which is a more comprehensive description of the boundary conditions of the nozzle structure components during the motor operation.

The invention will be further described in detail hereinafter with reference to the drawings.

### BRIEF DESCRIPTION OF THE DRAWINGS

FIG. 1 is a flowchart of the invention;

FIG. 2 is a configuration diagram of the numerical analysis of thermal structure according to the invention;

FIG. 3 is a model diagram of the invention;

FIG. 4 is a phase diagram of the material setting according to the invention;

FIG. 5 is a result diagram of the meshing according to the invention;

FIG. 6 is a radial stress diagram of the throat insert according to the invention;

FIG. 7 is a axial stress diagram of the throat insert according to the invention;

FIG. 8 is a circumferential stress diagram of the throat insert according to the invention.

### DETAILED DESCRIPTION OF THE PREFERRED EMBODIMENTS

In order to make the objectives, technical solutions and advantages clearer, the following further describes the invention in detail hereinafter with reference to the drawings. It should be understood that the following embodiment is only to explain the invention, not to limit the invention.

### EMBODIMENT

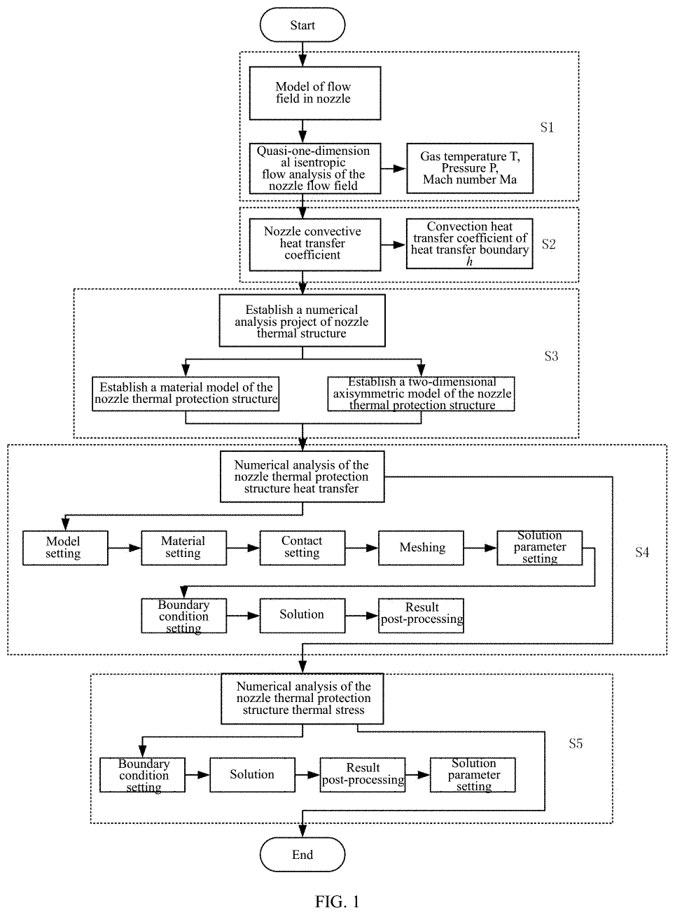

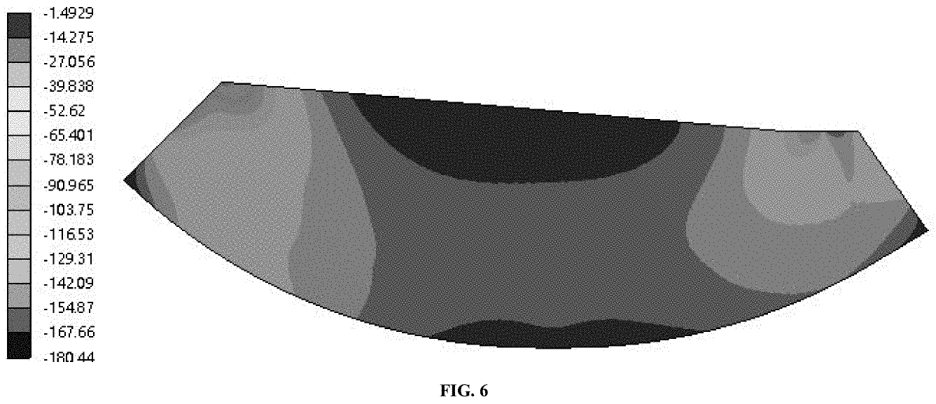

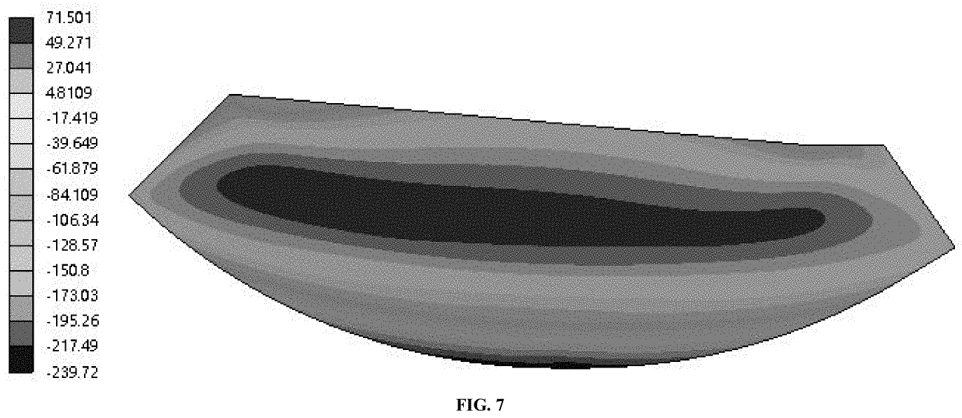

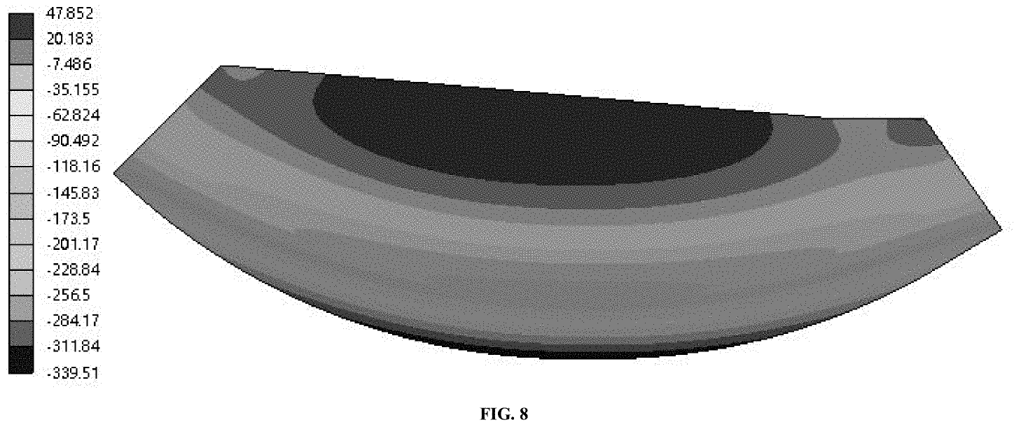

A thermal structure coupling analysis method of a solid rocket motor nozzle considering the structural gaps, as shown in FIG. 1-FIG. 8, comprising the following steps:

S1: establish the model of flow field in nozzle and ascertain the cross-sectional area at different positions along the nozzle axis, perform quasi-one-dimensional isentropic flow analysis of flow field in the nozzle by Newton iteration method, and obtain the gas temperature T, pressure P and Mach number Ma on any section along the nozzle axis, and ascertain the pressure and temperature boundary:

$$\frac{{T}_{0}}{T} = 1 + \frac{k - 1}{2} {Ma}^{2} ;$$

$$\frac{{P}_{0}}{P} = {( 1 + \frac{k - 1}{2} {Ma}^{2} )}^{\frac{k}{k - 1}} ;$$

$$\frac{A}{{A}_{t}} = {\frac{1}{Ma} [ \frac{( k - 1 ) {Ma}^{2} + 2}{k + 1} ]}^{\frac{k + 1}{2 ( k - 1 )}} ;$$

In the formula, T₀ is the total temperature of the combustion chamber, P₀ is the total pressure, Aₜ is the area of the nozzle throat, A is the cross-sectional area along the nozzle axis, k is the specific heat ratio of the gas;

S2: after the gas enters the nozzle, its flow accelerates sharply, and the turbulence effect is obviously increased, which greatly enhances the convection to the wall and forms high-speed forced-convection heat transfer. Therefore, here use the Bartz formula to ascertain the boundary of the nozzle convective heat transfer coefficient:

$$h = \frac{C}{{d}_{t}^{0.2}} \frac{{c}_{p} {μ}^{0.2}}{P {r}^{0.6}} {( \frac{m}{{A}_{t}} )}^{0.8} {( \frac{{d}_{t}}{{R}_{c}} )}^{0.1} {( \frac{{A}_{t}}{A} )}^{0.9} σ$$

In the formula: h is the forced convection heat transfer coefficient; C is the correction coefficient, C=0.026 when it is in subsonic flow, C=0.023 when it is in supersonic flow; dₜ is the diameter of the throat; cₚ is the constant-pressure specific heat; μ is the viscosity coefficient of the gas; Pr is the Prandtl number; m is the mass flow rate of the gas; R_{c} is the curvature radius of the curve segment of the throat; σ is the correction coefficient caused by considering the change of boundary layer parameters;

the correction coefficient thereof:

$$σ = \frac{1}{{[ \frac{1}{2} \frac{{T}_{w}}{{T}_{0}} ( 1 + \frac{k - 1}{2} {Ma}^{2} ) + \frac{1}{2} ]}^{0.65} {( 1 + \frac{k - 1}{2} {Ma}^{2} )}^{0.15}}$$

In the formula, T_{w} is the temperature of the nozzle wall; T₀ is the total temperature of the gas; k is the specific heat ratio of the gas; Ma is the Mach number flow along the nozzle axis;

Considering that the gas flow has a stagnation effect on the nozzle wall, in order to take a full account of the influence caused by the flow in the boundary layer, define the gas recovery temperature as Tᵣ

$${T}_{r} = T [ 1 + P {r}^{1 / 3} \frac{k - 1}{2} {Ma}^{2} ]$$

wherein the Prandtl number Pr and gas viscosity coefficient μ:

$$Pr = \frac{4 k}{9 k - 5} ;$$

$$μ = 11.83 \times 1 {0}^{- 8} \times {\overline{M}}^{0.5} \times {T}^{0.6} ;$$

In the formula, M̅ is the average molar mass of the gas;

Based on the above, set the quasi-one-dimensional isentropic flow analysis result of the flow field in the nozzle as input, and obtain the solution of the convective heat transfer coefficient h along the axial direction of the nozzle.

Therefore, the pressure boundary (P), temperature boundary (T), and convective heat transfer coefficient boundary (h) required for the numerical analysis of the nozzle thermal structure are all known.

S3: establish numerical analysis process for nozzle thermal structure:

proceed pre-treatment, including establishing a numerical analysis project of nozzle thermal structure; establishing a two-dimensional axisymmetric model of the nozzle thermal protection structure; establishing the material model of the nozzle thermal protection structure;

S4: proceed the numerical analysis of the heat transfer of the nozzle thermal protection structure, including model setting, material setting, contact setting, meshing, solution parameter setting, boundary condition setting, solution and result post-processing;

S5: proceed the numerical analysis of the thermal stress of the nozzle thermal protection structure, including solution parameter setting, boundary condition setting, solution and result post-processing.

Further, S3 comprising the following steps:

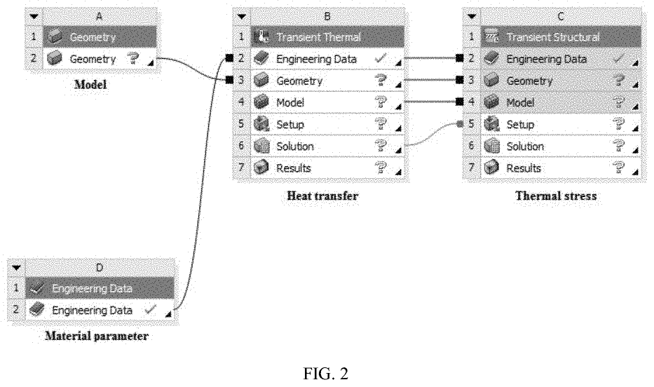

S3.1: establish a numerical analysis project of nozzle thermal structure in ANSYS Workbench, as shown in FIG. 2, including model module, material parameter module, heat transfer module and thermal stress module;

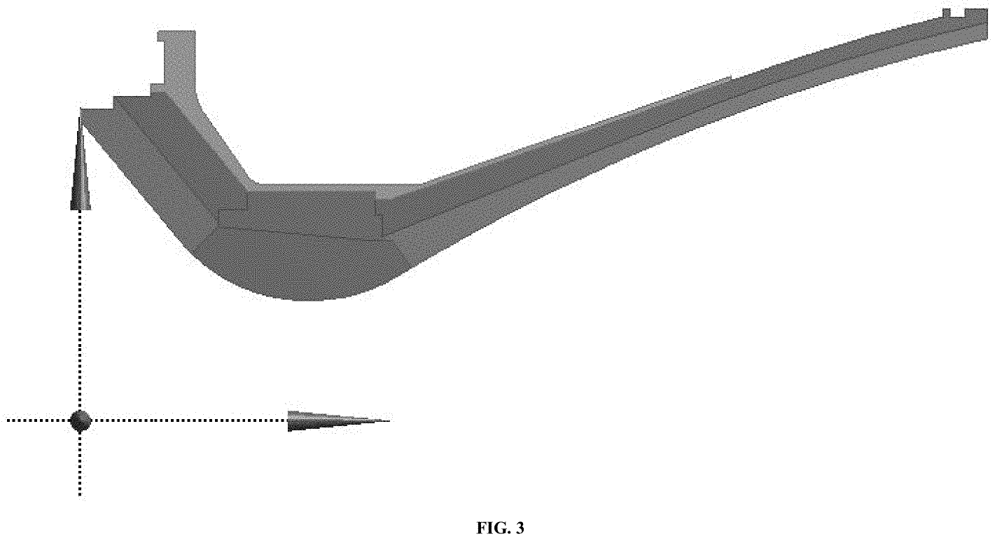

S3.2: double-click link A2 of the Model module, establish or import the two-dimensional axisymmetric model of the nozzle thermal protection structure into the model module, as shown in FIG. 3, and adjust the symmetry axis of the model to the Y axis.

S3.3: double-click link D2 of the material parameter module, according to the material composition of each part of the nozzle thermal protection structure, input the density (temperature-dependent), thermal expansion coefficient (temperature-dependent and anisotropic), elastic parameters (modulus, Poisson's ratio, etc., temperature-dependent, anisotropic) thermal conductivity (temperature-dependent and anisotropic) and specific heat parameters (temperature-dependent) in the material parameter module respectively, and establish the material model of the nozzle thermal protection structure.

Preferably, the S4 comprises the following steps:

S4.1: in the heat transfer module, access the heat transfer numerical analysis setting interface Mechanical, access Geometry in the project tree on the left, and set 2D Behavior in Definition to Axisymmetric;

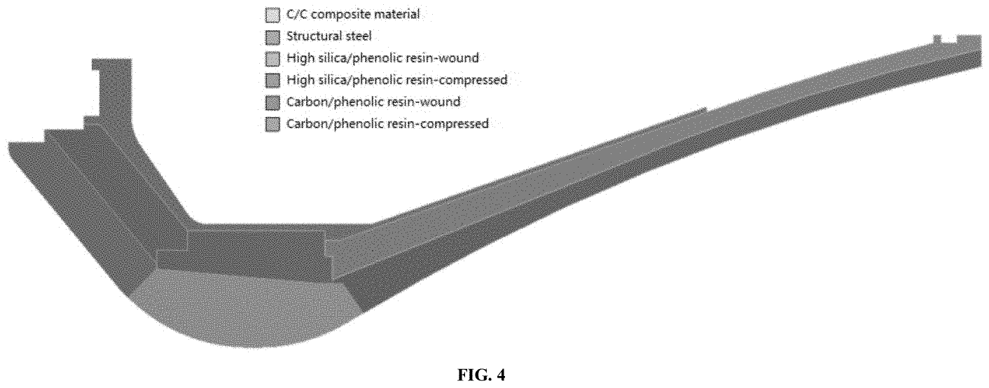

S4.2: under the Geometry tree in the heat transfer module, specify the materials of each structural component of the nozzle respectively, the phase diagram of the material setting is shown in FIG. 4;

S4.3: access Connections-Contacts, set all the contact pairs, set Type to Frictional, Friction Coefficient to 0.2, set Thermal Conductance to Manual, and Thermal Conductance Value to 1000 W/(m²·K);

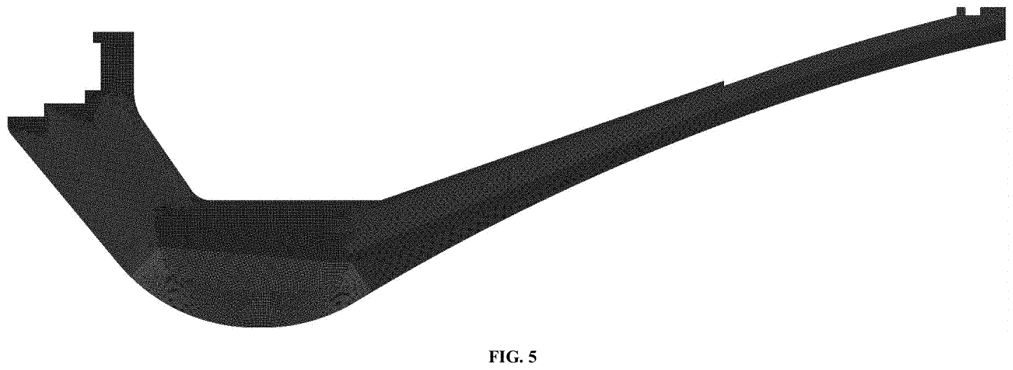

S4.4: access Mesh, alter the appropriate Element Size according to the size of the nozzle structure; select Update to start meshing, the result diagram of the meshing is shown in FIG. 5;

S4.5: access Analysis Settings, set Step End Time according to the actual working time of the motor, Auto Time Stepping is set to off, Define By is set to Substeps, Number of Substeps is set to 100;

S4.6: select the inner wall of the nozzle and add a Convection boundary; set both Film Coefficient and Ambient Temperature to Tabular Data, select Edit Data For to Ambient Temperature, set Independent Variable to Y, and enter the temperature along the axis of the nozzle obtained by the quasi-one-dimensional flow of the nozzle; select Edit Data For as Film Coefficient, set Independent Variable as Y, and enter the convective heat transfer coefficient along the nozzle axis; select the part of the outermost shell of the nozzle that is directly in contact with the air, add Convection, and set the Film Coefficient to 5 W/(m²° C.) (namely the default natural convective heat transfer coefficient between air and objects);

S4.7: access Solution, select Solve, and proceed numerical analysis of heat transfer of nozzle thermal protection structure;

S4.8: after the solution is completed, add a post-processing item to the Solution to obtain nozzle temperature field distribution diagram at the end of the operation. In the cloud diagram, it is clearly that at the interface of nozzle structure components, due to the existence of contact thermal resistance, the temperature gradient is large, which is prone to large stress concentration. This is significantly different from the temperature cloud diagram obtained without considering the contact problem. In addition, the method considers the factor of contact thermal resistance, which is more consistent to the actual situation. The temperature cloud diagram obtained by the solution is also closer to the actual temperature transfer of the nozzle. The result is more authentic and reliable, which has a guiding function on the motor design.

Preferably, the S5 comprises the following steps:

S5.1: in the thermal stress module, access Analysis Settings, set Step End Time to 1 s, Auto Time Stepping to off, Define By to Time, and Time Step to 1 s;

S5.2: select Suppress under Imported Load, select the inner wall of the nozzle and add the boundary of Pressure, and enter the pressure along the axis of the nozzle obtained by the quasi-one-dimensional flow of the nozzle; select the boundary along the radial direction at the junction of the outermost metal part of the nozzle and the combustion chamber, add a Displacement boundary, and set axial displacement thereof to 0;

S5.3: insert Commands under Transient and enter the solution command; access Solution, select Solve and start the numerical analysis of the thermal stress of the nozzle thermal protection structure;

S5.4: after the solution is completed, add a post-processing item in Solution to obtain the thermal stress cloud diagram of the nozzle at the end of the operation. they are respectively a radial stress diagram of the throat insert, a axial stress diagram of the throat insert and a circumferential stress diagram of the throat insert, on one hand, due to the contact thermal resistance, the temperature gradient between the nozzle assembly interfaces rises, which increases the stress of the throat insert; on the other, practice has shown that after considering the contact friction between components, the stress distribution of the throat insert boundary would increase or decrease. The thermal structure analysis of the nozzle that considers contact friction is more consistent to the actual operation, the component stress distribution obtained is more authentic and reliable, which plays a guiding role to the motor design.

The above are only preferred embodiments, and are not to limit the invention, any modification, equivalent replacement and improvement made within the spirit and principle of the invention shall all fall within protection scope of the invention.

1. A thermal structure coupling analysis method of a solid rocket motor nozzle considering the structural gaps, comprising the following steps:
S1: establish a model of flow field in nozzle and ascertain the cross-sectional area on spot at different positions along the nozzle axis, perform quasi-one-dimensional isentropic flow analysis of flow field in the nozzle by Newton iteration method, and obtain the gas temperature T, pressure P and Mach number Ma on any section along the nozzle axis, and ascertain the pressure and temperature boundary:
$$\frac{{T}_{0}}{T} = 1 + \frac{k - 1}{2} {Ma}^{2} ;$$
$$\frac{{P}_{0}}{P} = {( 1 + \frac{k - 1}{2} {Ma}^{2} )}^{\frac{k}{k - 1}} ;$$
$$\frac{A}{{A}_{t}} = {\frac{1}{Ma} [ \frac{( k - 1 ) {Ma}^{2} + 2}{k + 1} ]}^{\frac{k + 1}{2 ( k - 1 )}} ;$$
in the formula, T₀ is the total temperature of the combustion chamber, P₀ is the total pressure, Aₜ is the area of the nozzle throat, A is the cross-sectional area along the nozzle axis, and k is the specific heat ratio of the gas;
S2: use the Bartz formula to ascertain the boundary of the nozzle convective heat transfer coefficient:
$$h = \frac{C}{{d}_{t}^{0.2}} \frac{{c}_{p} {μ}^{0.2}}{P {r}^{0.6}} {( \frac{m}{{A}_{t}} )}^{0.8} {( \frac{{d}_{t}}{{R}_{c}} )}^{0.1} {( \frac{{A}_{t}}{A} )}^{0.9} σ$$
in the formula: h is the forced convection heat transfer coefficient; C is the correction coefficient, C=0.026 when it is in subsonic flow, C=0.023 when it is in supersonic flow; dₜ is the diameter of the throat; cₚ is the constant-pressure specific heat; μ is the viscosity coefficient of the gas; Pr is the Prandtl number; \dot{m} is the mass flow rate of the gas; R_{c} is the curvature radius of the curve segment of the throat; σ is the correction coefficient caused by considering the change of boundary layer parameters;
the correction coefficient thereof σ:
$$σ = \frac{1}{{[ \frac{1}{2} \frac{{T}_{w}}{{T}_{0}} ( 1 + \frac{k - 1}{2} {Ma}^{2} ) + \frac{1}{2} ]}^{0.65} {( 1 + \frac{k - 1}{2} {Ma}^{2} )}^{0.15}}$$
in the formula, T_{w} is the temperature of the nozzle wall; T₀ is the total temperature of the gas; k is the specific heat ratio of the gas; Ma is the flowing Mach number on spot along the nozzle axis;
wherein, define the gas recovery temperature as Tᵣ:
$${T}_{r} = T [ 1 + P {r}^{1 / 3} \frac{k - 1}{2} {Ma}^{2} ]$$
wherein, the Prandtl number Pr and gas viscosity coefficient μ:
$$Pr = \frac{4 k}{9 k - 5} ;$$
$$μ = 11.83 \times 1 {0}^{- 8} \times {\overline{M}}^{0.5} \times {T}^{0.6} ;$$
in the formula, M̅ is the average molar mass of the gas;
S3: proceed pre-treatment, including establishing a numerical analysis project of nozzle thermal structure; establishing a two-dimensional axisymmetric model of the nozzle thermal protection structure; establishing a material model of the nozzle thermal protection structure;
S4: proceed the numerical analysis of the heat transfer of the nozzle thermal protection structure, including model setting, material setting, contact setting, meshing, solution parameter setting, boundary condition setting, solution and result post-processing;
S5: proceed the numerical analysis of the thermal stress of the nozzle thermal protection structure, including solution parameter setting, boundary condition setting, solution and result post-processing.

2. The thermal structure coupling analysis method of a solid rocket motor nozzle considering the structural gaps according to claim 1, wherein S3 comprising the following steps:
S3.1: establish the numerical analysis project of nozzle thermal structure in ANSYS Workbench, including model module, material parameter module, heat transfer module and thermal stress module;
S3.2: establish or import the two-dimensional axisymmetric model of the nozzle thermal protection structure into the model module, and adjust the symmetry axis of the model to the Y axis;
S3.3: according to the material composition of each part of the nozzle thermal protection structure, input the density, thermal expansion coefficient, elastic parameter, thermal conductivity and specific heat parameter in the material parameter module respectively, and establish the material model of the nozzle thermal protection structure.

3. The thermal structure coupling analysis method of a solid rocket motor nozzle considering the structural gaps according to claim 2, wherein S4 comprising the following steps:
S4.1: in the heat transfer module, access the heat transfer numerical analysis setting interface Mechanical, access Geometry in the left project tree, and set 2D Behavior in Definition to Axisymmetric;
S4.2: under the Geometry tree in the heat transfer module, specify the materials of each structural component of the nozzle respectively;
S4.3: access Connections-Contacts, set all contact pairs, set Type to Frictional, Friction Coefficient to 0.2, set Thermal Conductance to Manual, and Thermal Conductance Value to 1000 W/(m²·K);
S4.4: access Mesh, alter the appropriate Element Size according to the size of the nozzle structure; select Update to start meshing;
S4.5: access Analysis Settings, set Step End Time according to the actual working time of the motor, Auto Time Stepping is set to off, Define By is set to Substeps, Number of Substeps is set to 100;
S4.6: select inner wall of the nozzle and add a Convection boundary; set both Film Coefficient and Ambient Temperature to Tabular Data, select Edit Data For to Ambient Temperature, set Independent Variable to Y, and enter the temperature along the axis of the nozzle obtained by the quasi-one-dimensional flow of the nozzle; select Edit Data For as Film Coefficient, set Independent Variable to Y, and enter the convective heat transfer coefficient along the nozzle axis; select the part of the outermost shell of the nozzle that is directly in contact with the air, add Convection, and set the Film Coefficient to 5 W/(m²·° C.);
S4.7: access Solution, select Solve, and proceed numerical analysis of heat transfer of nozzle thermal protection structure;
S4.8: after the solution is completed, add a post-processing item to the Solution to obtain nozzle temperature field distribution diagram at the end of the operation.

4. The thermal structure coupling analysis method of a solid rocket motor nozzle considering the structural gaps according to claim 3, wherein S5 comprising the following steps:
S5.1: in the thermal stress module, access Analysis Settings, set Step End Time to 1 s, Auto Time Stepping to off, Define By to Time, and Time Step to 1 s;
S5.2: select Suppress under Imported Load, select the inner wall of the nozzle and add a Pressure boundary, enter the pressure along the axis of the nozzle obtained by the quasi-one-dimensional flow of the nozzle; select the boundary along the radial direction at the junction of the outermost metal part of the nozzle and the combustion chamber, add a Displacement boundary, and set axial displacement thereof to 0;
S5.3: insert Commands under Transient and enter the solution command; access Solution, select Solve and start the numerical analysis of the thermal stress of the nozzle thermal protection structure;
S5.4: after the solution is completed, add a post-processing item in Solution to obtain a thermal stress cloud diagram of the nozzle at the end of the operation.
